(19) United States
(12) Patent Application Publication
(10) Pub. No.: US 2009/0277341 A1
(43) Pub. Date: Nov. 12, 2009

(54) SWEETENER STICK FOR STIRRING A BEVERAGE

(76) Inventor: Thor Daniel Hjaltason, Arlington, TX (US)

Correspondence Address: CARR LLP, 670 FOUNDERS SQUARE, 900 JACKSON STREET, DALLAS, TX, 75202, US

(21) Appl. No.: 12/429,076

(22) Filed: Apr. 23, 2009

Related U.S. Application Data
(60) Provisional application No. 61/047,375, filed on Apr. 23, 2008.
(60) Provisional application No. 61/073,312, filed on Jun. 17, 2008.

(51) Int. Cl. A47G 21/04; B67D 5/64; B65D 25/00

(52) U.S. Cl. 99/494; 222/174; 206/220

(57) ABSTRACT

An apparatus comprises a stick for stirring a liquid. The apparatus also comprises an ingredient that is coupled to the stick for at least a partial dissolution in the liquid.

### CROSS-REFERENCE TO RELATED APPLICATIONS

This application relates to, and claims the benefit of the filing date of, co-pending U.S. provisional patent application Ser. No. 61/047,375 entitled BEVERAGE STIRRING AND SWEETENING STICK, filed Apr. 23, 2008, and co-pending U.S. provisional patent application Ser. No. 61/073,312 entitled BEVERAGE STIRRING AND SWEETENING STICK WITH U-NECK, filed Jun. 17, 2008, the entire contents of which are incorporated herein by reference for all purposes.

### FIELD OF THE INVENTION

The present invention relates to, generally, a sweetener stick to insert into a beverage for stirring, and, more specifically, to a sweetener stick with a u-neck to insert into a beverage for stirring.

### BACKGROUND

Lollipops and hard candy of different flavors, mounted on a wooden, compressed paper or plastic stick, are well known. However, such sugar-covered sticks have limited utility in sweetening beverages, such as in conventional “to-go” cups having covers. Furthermore, lollipops are made to be sucked on, and are not easily dissolved.

### OBJECTS OF THE INVENTION

It is therefore an object of the invention to overcome at least some of the foregoing disadvantages of the prior art.

It is a further object of the present invention to provide an apparatus and a system that makes it more convenient, cleaner and quicker to add dissolvable sweeteners such as sugar, low calorie sweeteners, different flavorings and/or creamer to a cup of coffee, tea or other beverages. One embodiment of the present invention caters especially to the popular “to go” cups of coffee and other beverages presently bought from locations like Starbucks™, Seattle Coffee™ and other retail outlets that offer these beverages. The present invention offers a new way to add and dissolve the sweeteners to these and other beverages.

### SUMMARY OF THE INVENTION

In accordance with one embodiment, an apparatus comprises a stick for stirring a liquid. The apparatus further comprises an ingredient that is coupled to the stick for at least a partial dissolution in the liquid.

In accordance with another embodiment, a system comprises a lid for substantially sealing a top of a beverage cup, wherein the lid is configured accept a sweetener stick. The sweetener stick includes a stick for stirring a liquid; and an ingredient that is coupled to the sweetener stick for at least a partial dissolution in the liquid.

### BRIEF DESCRIPTION OF THE DRAWINGS

The foregoing and other objects, features and advantages will be apparent to those skilled in the art upon review of the detailed description herein, with reference to the drawings, in which:

FIGS. 1A and 1B depict embodiments of stages of coupling a sweetener stick to a device;

FIG. 2 depicts an embodiment of an adjustable device to be used with a sweetener stick;

FIGS. 3A-3D depicts an embodiments and positions of an adjustable device that can be used with a sweetener stick;

FIG. 4A depicts an embodiment of a hook on an end of a sweetener stick;

FIG. 4B and FIG. 4C depict an embodiment of a device having a cross slit that can either slide from the top or a side of a sweetener stick;

FIG. 4D depicts an alternative embodiment of a sweetener stick having an alternative device integral to the sweetener stick;

FIG. 5 depicts an embodiment of a sweetener stick having compressed sweeteners wrapped in a protective wrapping;

FIGS. 6A and 6B illustrates a cross cut slit opening that is situated on a lid of a beverage for use with a sweetener stick;

FIGS. 7A-7E illustrate a sweetener stick with a neck, and an insertion into various beverages of the sweetener stick with the neck;

FIG. 8A illustrates another embodiment of an adjustable device that can be coupled and adjusted up and down a sweetener stick;

FIG. 8B illustrates a sweetener stick of FIG. 4C combined with a wrapping that then has the wrapping removed;

FIG. 8C illustrates various embodiments of sweeteners coupled to an end of a sweetener stick having a fixed device; and

FIGS. 9A-9D illustrate a dissolution of sweeteners that are coupled into an end of a sweetener stick of the present invention.

### DETAILED DESCRIPTION

In conventional systems, sugar-covered sticks have a limited utility in sweetening beverages, such as in conventional “to-go” beverage cups having covers, because the size and shape of the candy-covered end does not readily fit through slots or openings in the covers. Furthermore, even if the opening in the cover was modified to be large enough to accept the sugar-covered end, the other end of the stick would simply fall into the cup, rather than remaining extended so that the other end of the stick could be used as an adjusting and stirring device. The present invention addresses at least some of these problems.

Generally, the present invention is directed towards a stick made out of wood, compressed paper, plastics, or other similar materials containing or coupled to compressed sweeteners such as low calorie sweeteners, sugar, flavorings, or dairy powder formed onto at least one end of the stick. For convenience, but not for limitation, the following will generally refer to the stick as a “sweetener stick” although it is to be expressly understood that the stick may have flavors, creamers and other edible substances placed on it that are not necessarily sugar or necessarily even sweet.

Again, generally, the sweetener stick has compressed dissolvable sweeteners containing a mass of sugar, dairy powder or different kind of flavorings that are mounted or formed around one end of the stick. The stick can have, for example, an adjustable device made out of wood, compressed paper, plastic or similar material that either clips or slides onto the opposing end for adjustments, or a stick with a formed hook at the opposing end. The device, such as an adjustable, device allows: a controlled insertion of the sweetener stick into the beverage, including insertion depth; a stirring of the beverage, or both. In one embodiment, the stick carrying the compressed dissolvable sweeteners will be inserted to mix with the cold or hot beverage in a cup when used in conjunction with a beverage cup made of plastic, paper or foam and having a fitting lid comprising a cut slot or opening.

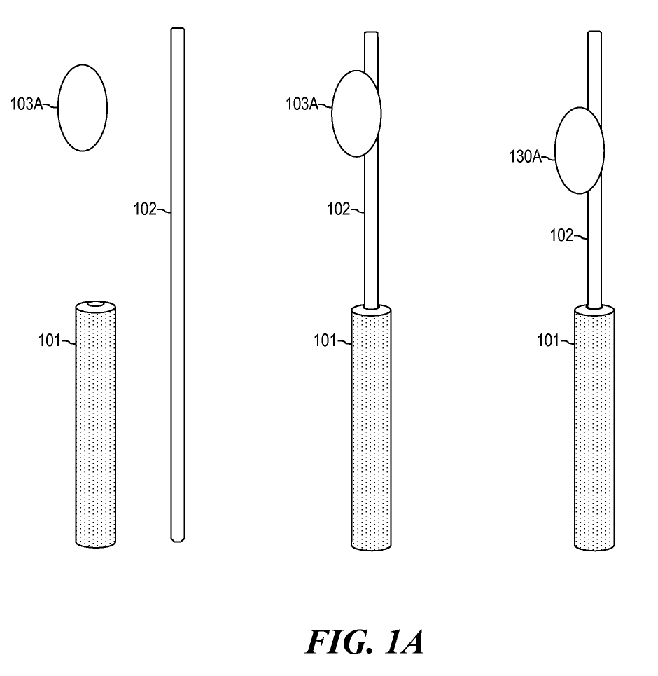

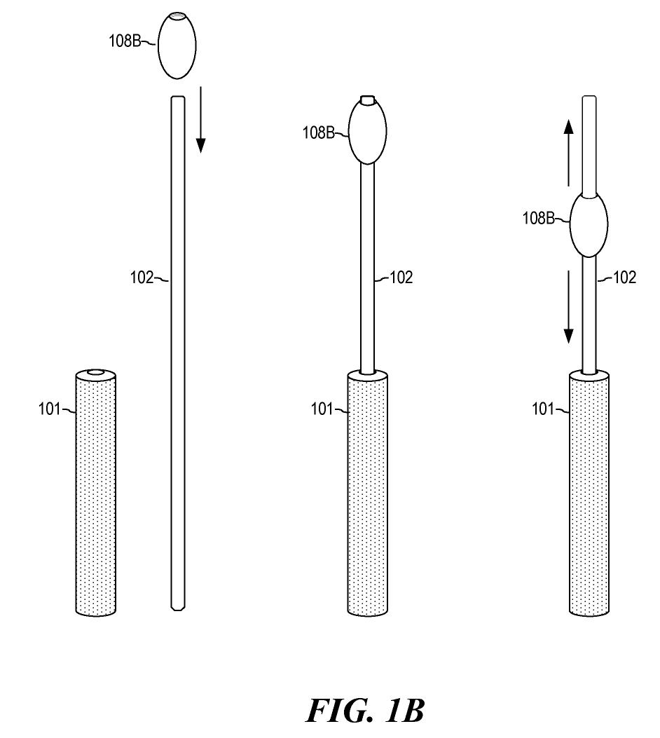

Turning now to FIGS. 1A-3D, in various embodiments of the present invention, a compressed mass of sweeteners/sugar granulates/dairy/flavorings 101 is formed and mounted on one end of a cylinder-shaped stick 102 (“sweetener stick”) made of compressed paper, wood or plastic.

In further embodiments, an adjustable device can be provided to be used with the sweetener stick 102. In one embodiment, an adjustable device 103A of FIG. 1A clips onto the sweetener stick 102 and slides down an outside of the sweetener stick 102. In another embodiment, an adjustable device 108B of FIG. 1B slides over the stick 101. In the illustrated embodiments, both adjustable devices 103A and 108B act as: a controlled insertion of the sweetener stick into a beverage, a stirring of the beverage, or both.

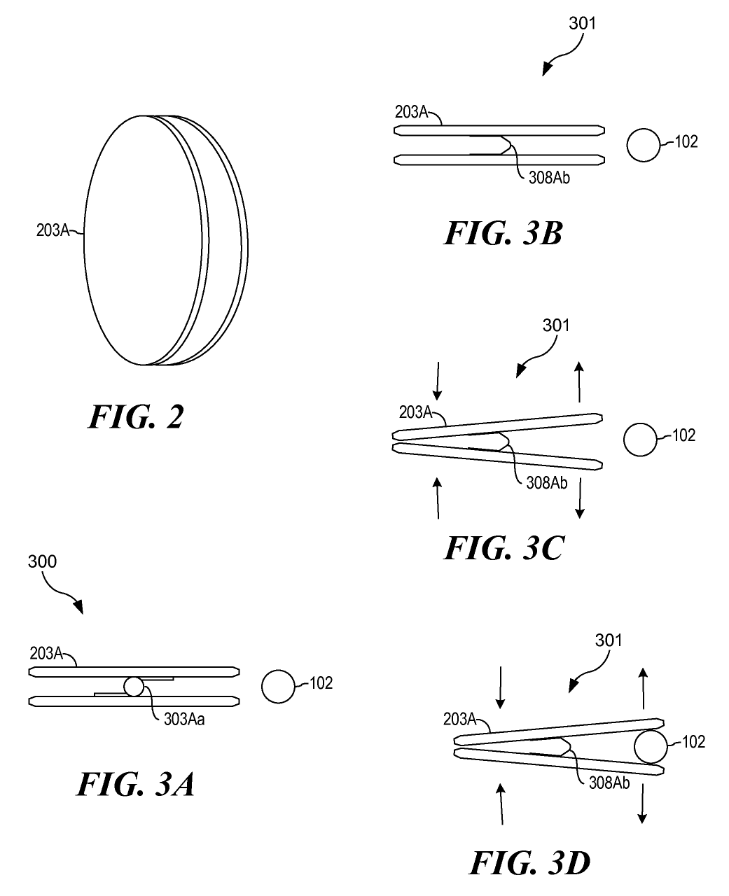

Turning briefly to FIG. 2, illustrated is another embodiment of a device 203A that is used as part of adjustable devices 300 and 301, to be described in more detail below. Generally, device 203A is used as an internal part of a clip.

Turning now to FIGS. 3A-3D, in one embodiment, the device 203A can be part of a clip 300 or a clip 301 that quickly clips on the sweetener stick 102 and can be adjusted easily up and down on the stick 102. This can also be used with or without the adjustable device 108B.

The clip may include metal springs 303Aa, such as illustrated in FIG. 3A, or plastic springs 308Ab, such as illustrated in FIG. 3B. As is illustrated in FIGS. 3C through 3D, the clip 301 is opened and then adjusted to grip the sweetener stick 102. The clip 300 and 301 can be formed or made out of plastic, wood or any other material and may include both different shapes, forms, sizes or even advertising materials for brands and logos.

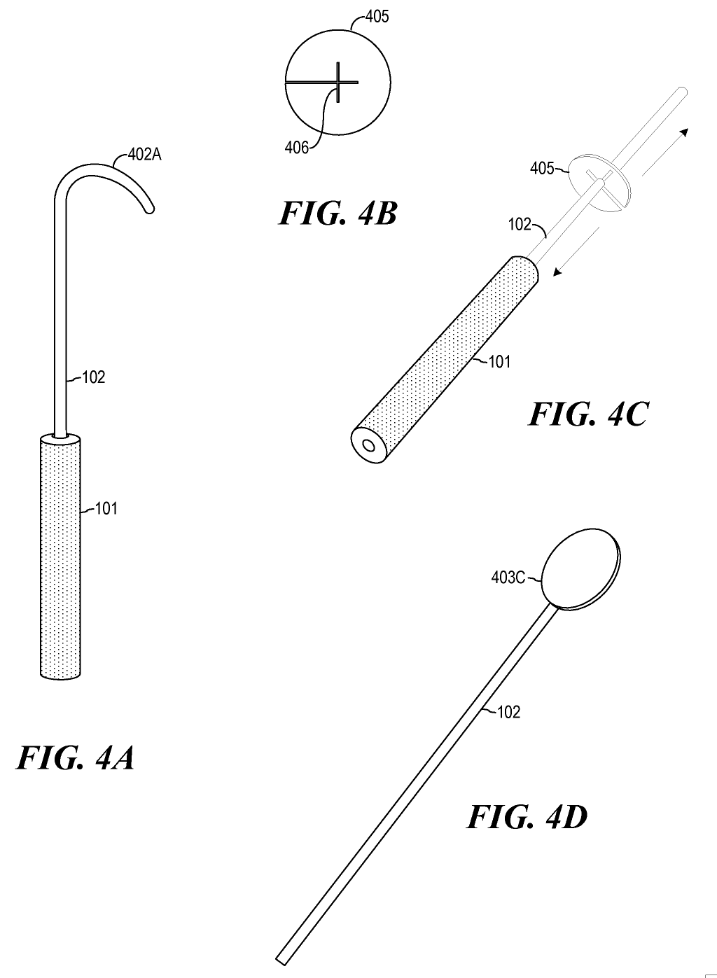

Turning now briefly to FIG. 4A, in one embodiment of the present invention, the sweetener stick 102 can be formed to have or include a hook 402A for added safety and control that can be used with or without the adjustable device clips 300 and 301.

Turning now to FIG. 4B and FIG. 4C, in one embodiment, an adjustable device 405 has a cross cut slit 406 that can either slide from the top or the side onto the stick 102 for adjusting a depth of insertion into a beverage.

Turning now to FIG. 4D, illustrated is a sweetener stick 102 having a device 403C that is substantially round, and used for stirring. The sweetener stick 102 and the device 403C can be an integral device. The device 403C can be fixed and not adjustable. The sweetener stick 102 can have sweeteners 101 (not illustrated) added to the stick. The device 403 can be grasped by a user to stir a beverage to stir the sweetener stick 102, or otherwise act as a stop.

Generally, the sugar stick 102, as an invention, serves a purpose of making it easier, quicker, cleaner and more enjoyable to insert and dissolve sweeteners in one's beverage. For example, all devices 103A, 108B, and the various clips of FIGS. 3A-4C serve a purpose of stirring control, placement, and safety while dissolving, and then drinking. All of these devices may be used jointly or independently of each other.

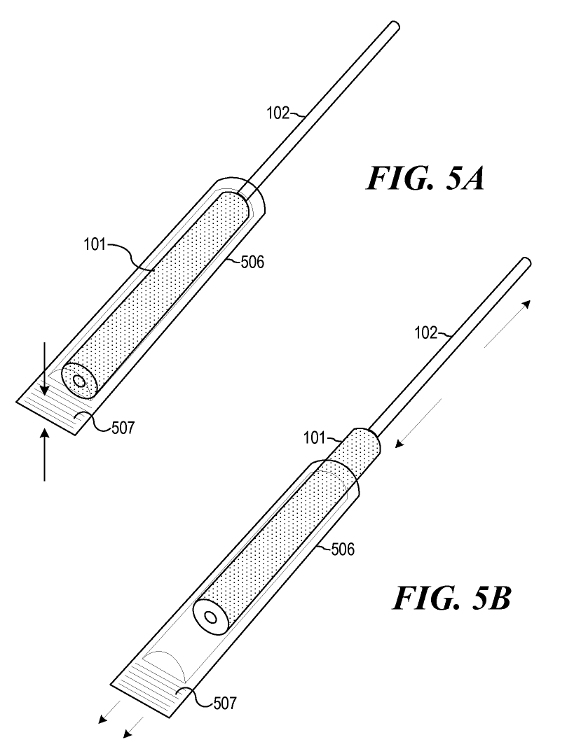

Turning now to FIG. 5, illustrated is an embodiment of the sweetener stick 102 wherein a mass of compressed sweeteners 101 may be wrapped in a protective paper or plastic wrapping 506 comprising an area at the bottom of the wrapping 507 large enough to enable a thumb and forefinger to pull the wrapping for easy removal.

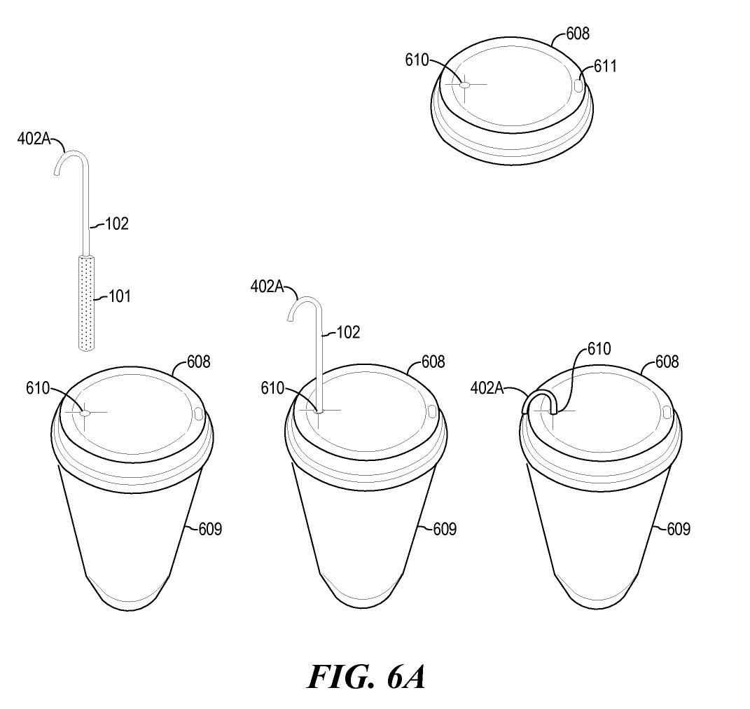

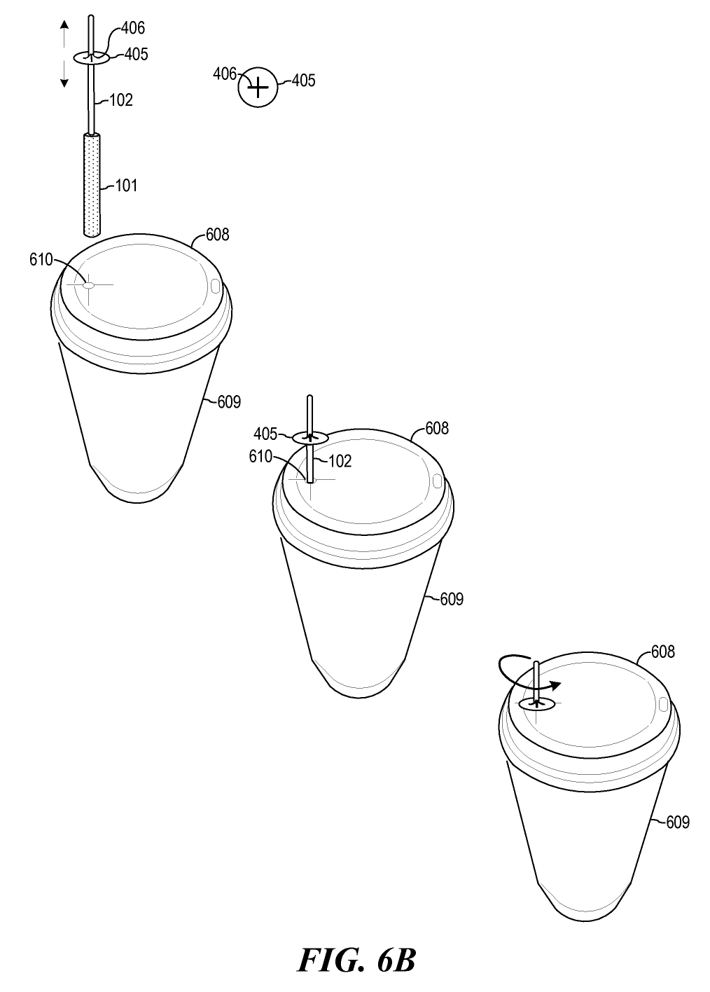

Turning now to FIGS. 6A and 6B, illustrated is an alternative aspect of the present invention. A lid 608 used to seal a top of a beverage cup 609 and designed to accept the sweetener stick 102. A cross cut slit opening 610 is situated at or near the edge of the lid 608 and on the opposing end of a sipping vent 611.

The slit 610 is made to allow for the insertion by pressure of the sweetener stick 102 with the sweeteners 101. The slit 610 will also, at the same time, act as a resister for the stick 102. In FIG. 6A, the stick 102 has a hook 402A on the opposing end of the stick 102 to prevent the stick 102 from falling into the cup 609. In an alternative embodiment of FIG. 6B, the stick 102 has an adjustable device 405 with a cross slit 406 on the opposing end of the stick 102 to prevent the stick 102 from falling into the cup 609. The lid 608 may be made out of transparent or nontransparent substrate or any foam, plastic or paper substrate of any color. When the compressed mass of sweeteners 101 is either completely or partially dissolved, the stick 102 can then safely be removed and recycled or thrown away.

Generally, the amount of sugar or dairy mass mounted on the stick 102 can vary. The sugar stick 102 will replace or be an addition to the small sugar paper bags and otherwise different sweeteners or flavorings added into the beverages. The sugar or dairy mass may have different shapes, sizes, colors or forms such as cylinder, round, square, flat or any shape. The sugar or dairy mass may have one or two or more servings depending on size of sugar or dairy mass and may be able to be mixed internally.

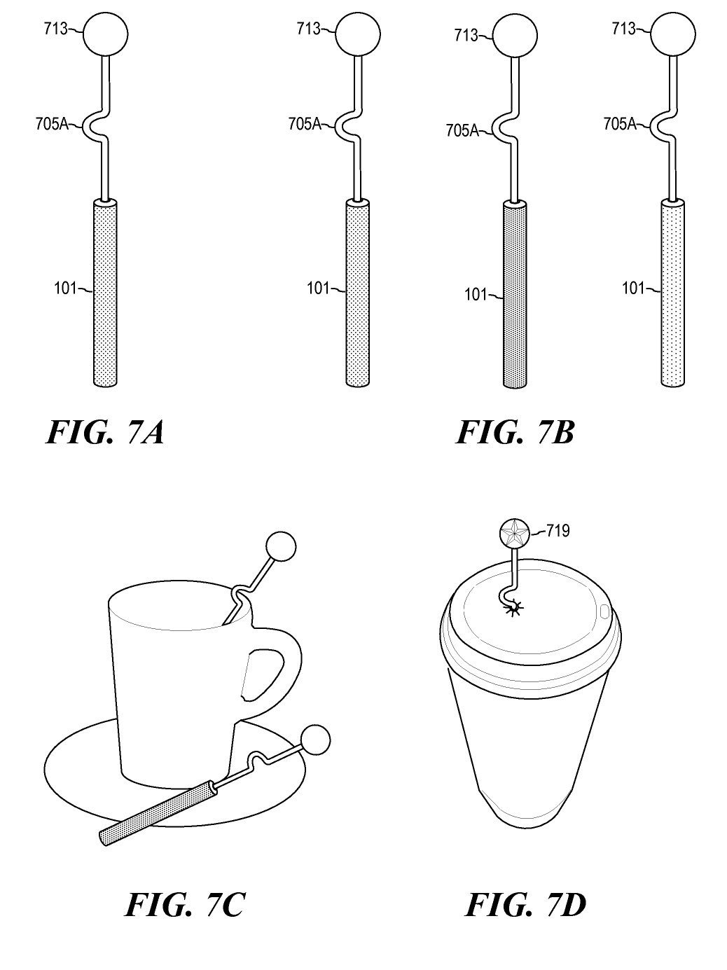

Turning now to FIG. 7A, illustrated is another embodiment of a sweetener stick 102. In this embodiment, a “u” neck 705A, or other shape bend, is provided in the stick, such as in FIG. 7A. In the illustrated embodiment, the sweetener stick 102 also has a ball 713 on the end of the sweetener stick 102, but the ball 713 is not necessary to a practice of the invention of the u neck 705A.

Turning now to FIG. 7B, a plurality of sweetener sticks having u-necks 705A are disclosed in FIG. 7B, each sweetener stick 102 with its own type of sweetener 101. A ball 713 can be used on the end of a sweetener stick 102, as illustrated, but is not essential where a neck 705A is provided in the sweetener stick 102. The neck 705A provides novelty to the stick and has purpose as well in terms of use, such as those described above.

In one aspect, when used in a conventional coffee mug or cup, such as illustrated in FIG. 7C, without a cap, the neck 705A acts as a stopping/resting place for the sweetener stick 102 and helps keep the sweetener stick 102 out of the way.

In another aspect, in a “to go” type cup with a cover, such as illustrated in FIG. 7D, or in another cup with a cover and a hole or other opening in the cover through which the stick can extends, the neck 705A holds the stick 102 up, to keep the sweetener part of the stick suspended above the bottom of the cup. Furthermore, the neck 705A keeps the entire stick from falling through the hole in the cap into the cup. The neck 705A, which holds the sweetener stick 102 in place, also provides stirring control, because it can pivot against the hole in the cap it is placed in while stirring takes place, such as is illustrated in FIG. 7D. As is also shown in FIG. 7D, a ball can be replaced with another shape, such as a logo 719, for advertising or other purposes.

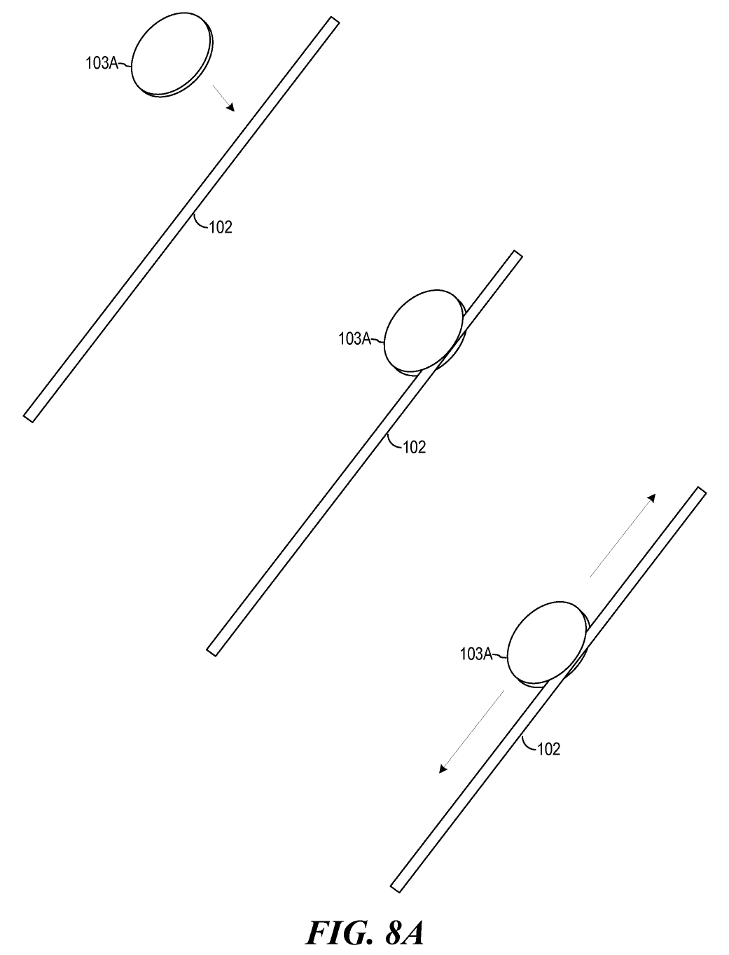

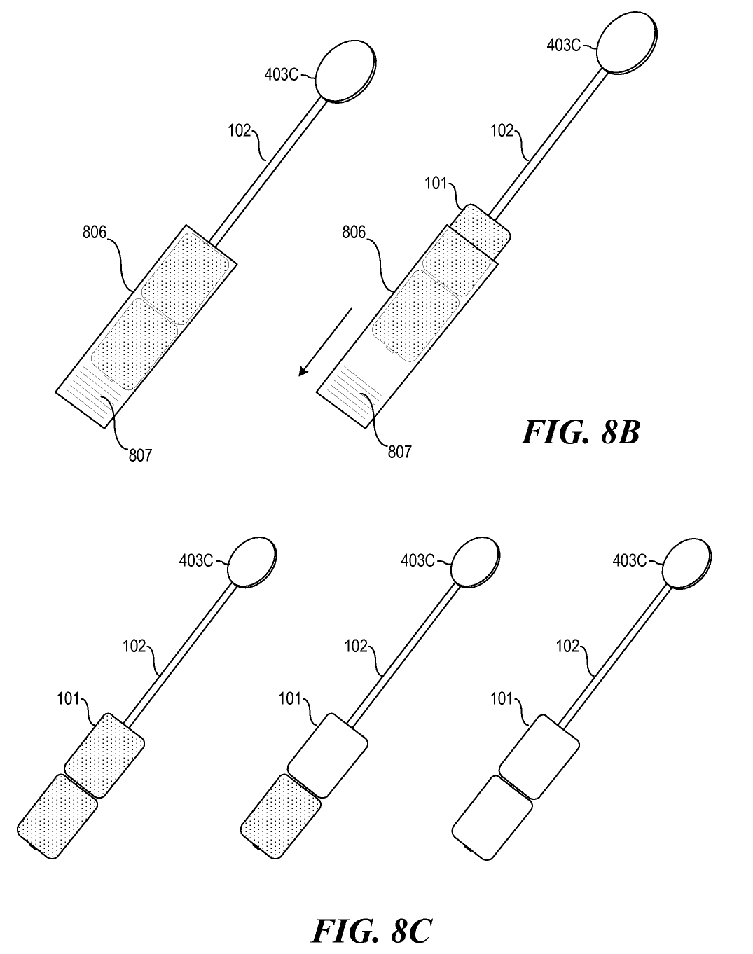

Turning now to FIG. 8A, illustrated is another embodiment of an adjustable device that can be adjusted up and down the sweetener stick 102. The adjustable device 103A is illustrated first as coupling to the sweetener stick 102, then traversing the sweetener stick 102.

Turning now to FIG. 8B, illustrated is a sweetener stick 102 of FIG. 4C combined with a wrapping 806. The wrapping 806 has grooves 807 that are used to help unwrap and expose the sweeteners 101 when it is desired to remove the wrapper 806.

Turning now to FIG. 8C, illustrated are a plurality of sweetener sticks 102 of FIG. 4C, each one having differing sweeteners 101.

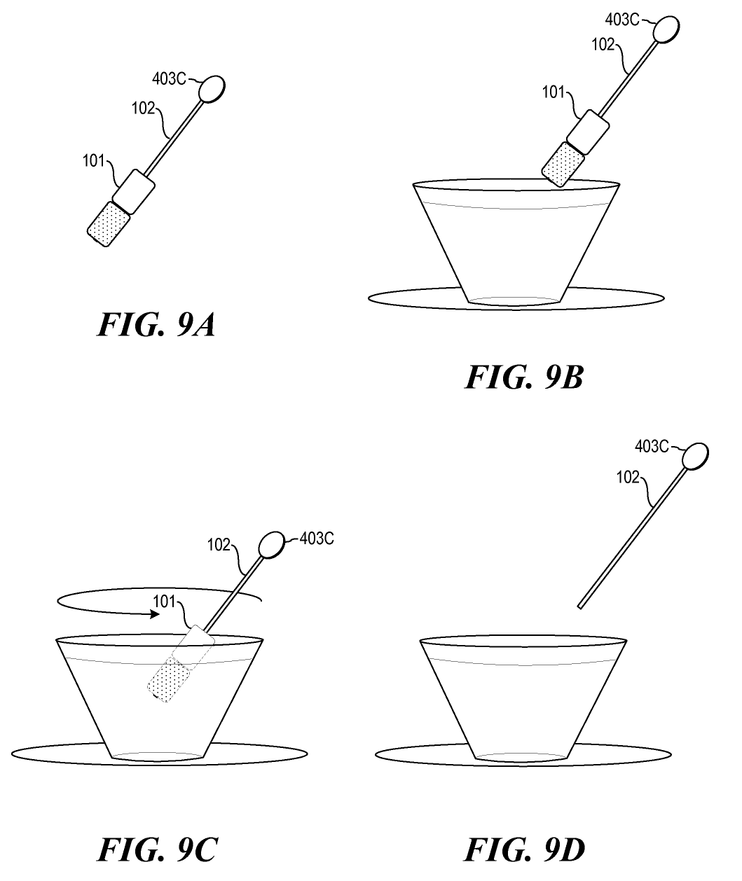

Turning now to FIGS. 9A-9D, illustrated is a dissolution of a sweetener 101 of a sweetener stick 102 with a device 403C. In FIG. 9A, the sweetener stick has two separate types of sweeteners 101 attached. In FIG. 9B, the sweetener stick 102 is about to be inserted into a beverage. In a FIG. 9C, the sweetener stick 102 is mixed in a beverage. In a FIG. 9D, it is seen that the sweetener 101 has dissolved from the sweetener stick 102, and the stick 102 may therefore be disposed.

Generally, the present invention can also be used in a traditional coffee or tea cup and therefore replace or improve upon the traditional way of adding sugar to a cup of coffee with a teaspoon or simply replacing the teaspoon as a stirring tool to any kind of sugar or additives added. The sugar or dairy may have different shapes, sizes, colors or forms such as cylinder, round, square, flat or any shape. The sugar or dairy may have one or two or more servings depending on size of sugar or dairy and may be able to be mixed internally. The present invention therefore merges two aspects into one. The present invention includes the ingredients and the carrying and stirring component.

Although the invention has been described with reference to specific embodiments, these descriptions are not meant to be construed in a limiting sense. Various modifications of the disclosed embodiments, as well as alternative embodiments of the invention, will become apparent to persons skilled in the art upon reference to the description of the invention. It is therefore contemplated that the claims will cover any such modifications or embodiments that fall within the true scope and spirit of the invention.

What is claimed is:

1. An apparatus, comprising:
a stick for stirring a liquid; and
an ingredient that is coupled to said stick for at least a partial dissolution in said liquid.

2. The apparatus of claim 1, wherein said ingredient is a sweetener.

3. The apparatus of claim 1, further comprising a device coupled to said stick as an aid to said partial dissolution.

4. The apparatus of claim 3, wherein said device is a neck in said stick.

5. The apparatus of claim 3, wherein said device is a hook at an end of said stick.

6. The apparatus of claim 3, wherein said device is an adjustable device.

7. The apparatus of claim 6, wherein said adjustable device is a clip.

8. The apparatus of claim 7, wherein said clip includes elements selected from the group consisting of:
a) metal; and
b) plastic.

9. The apparatus of claim 6, wherein said adjustable device can attach and slide on a side of said stick.

10. The adjustable device of claim 6, wherein said adjustable device is pierced through by said stick.

11. The adjustable device of claim 9, wherein said adjustable device has a cross slit.

12. The apparatus of claim 1, further comprising a second ingredient that is coupled to said stick for at least a partial dissolution in said liquid.

13. The apparatus of claim 1, wherein said aid to at least said partial dissolution includes employing said device as a control of an insertion depth of said stick into said liquid, wherein said liquid is a beverage.

14. The apparatus of claim 1, wherein said aid to at least said partial dissolution includes grasping said device for a purpose of stirring said liquid with said stick, wherein said liquid is a beverage.

15. A system, comprising:
a lid for substantially sealing a top of a beverage cup, wherein said lid is configured accept a sweetener stick,
said sweetener stick including:
a stick for stirring a liquid; and
an ingredient that is coupled to said stick for at least a partial dissolution in said liquid.

16. The system of claim 15, wherein said lid has a cross cut.

17. The system of claim 15, further comprising a device, coupled to said stick, employable as an aid to said partial dissolution.

18. The system of claim 17, wherein said lid can act a resistor to said device.

19. The system of claim 17, wherein said device is a clip that is coupled to said stick.
